(19) United States
(12) Patent Application Publication
(10) Pub. No.: US 2008/0190844 A1
(43) Pub. Date: Aug. 14, 2008

(54) Methods, processes and apparatus for biological purification of a gas, liquid or solid; and hydrocarbon fuel from said processes

(76) Inventor: Richard Alan Haase, Missouri City, TX (US)

Correspondence Address: RICHARD A. HAASE (INVENTOR), 4402 RINGROSE DRIVE, MISSOURI CITY, TX, 77459, US

(21) Appl. No.: 12/069,708

(22) Filed: Feb. 12, 2008

Related U.S. Application Data
(60) Provisional application No. 60/901,188, filed on Feb. 13, 2007.

(51) Int. Cl. C02F 3/02; C02F 3/00; B01D 21/26; C02F 1/38

(52) U.S. Cl. 210/622; 210/601; 210/767; 210/787

(57) ABSTRACT

This invention relates to improved methods, processes and apparatus for the removal of sulfides from a gas, liquid or solid (substance) wherein the substance is contacted with an aqueous solution. The instant invention presents methods and processes wherein at least one of H₂S, SO₂ and CS₂ is chemically converted in an aqueous media to a salt and/or compound comprising sulfur and a cationic moiety. Said salt and/or compound comprising sulfur and a cationic moiety is herein termed a “Sulfur Salt”. After formation of the Sulfur Salt, the Sulfur Salt is converted to elemental sulfur with a bacterium capable of metabolizing sulfur. The preferred bacterium for metabolizing sulfur is a strain from the genus Thiobacillus. The most preferred strain from the genus Thiobacillus is Thiobacillus denitrificans. The instant invention prefers an aqueous operating pH of between 6.0 and 8.0, while the most preferred aqueous pH is between 6.0 and 7.0.

### RELATED APPLICATION DATA

This application claims priority based on U.S. Provisional Application 60/901,188 filed Feb. 13, 2007.

### BACKGROUND OF THE INVENTION

1. Field of the Invention

This invention relates to improved methods, processes and apparatus for the removal of sulfides from a gas, liquid or solid (substance) wherein the substance is contacted with an aqueous solution. Sulfides are herein described as at least one of H₂S, SO₂ and CS₂. The instant invention presents methods and processes wherein at least one of H₂S, SO₂ and CS₂ is chemically converted in an aqueous media to a salt and/or compound comprising sulfur and a cationic moiety. Said salt and/or compound comprising sulfur and a cationic moiety is herein termed a “Sulfur Salt”. After formation of the Sulfur Salt, the Sulfur Salt is converted to elemental sulfur with a bacterium capable of metabolizing sulfur. As biological sludge is developed, a portion of the biological sludge is separated wherein said portion is then centrifuged to obtain the sulfur from the bacterium. The cationic moiety, removed from the Sulfur Salt, is then recycled in the aqueous media to contact the gas stream containing sulfides. It is preferred that the substance, if a gas stream, be contact the aqueous media in a scrubbing tower, as known in the art.

### BACKGROUND OF THE INVENTION

Sulfides are noxious and toxic gases which are present in many organic and aqueous environments, such as natural gas, crude oil, refined gasoline, refined diesel, refined kerosene, wastewater systems, food processing plants, etc.

The presence of sulfur compounds, such as sulfide, in a substance, such as waste water, has many adverse consequences, such as: corrosive action on concrete and steel, high carbon based chemical oxygen demand (CCOD), leading to oxygen depletion in the receiving water after discharge of the waste water, involving environmental pollution and/or high environmental levies, toxic effects on man and animals, serious stench.

While sulfide(s) can be removed from waste water by chemical oxidation, stripping and precipitation, biological purification methods have become increasingly important. Biological removal of sulfide(s) can be performed using phototrophic sulfur bacteria (also accompanied by sulfur production) as well as using denitrifying bacteria. Sulfide can also be converted to sulfate by oxygen consuming bacteria in activated sludge. Sulfur production using oxygen consuming bacteria has advantages over the use of phototrophic bacteria since aerobic conversion proceeds much faster than anaerobic (phototrophic) conversion and light supply in a turbid sulfur reactor is not easy, whereas oxygen can be supplied in an aerobic reactor in a simple way without problems. Nitrate is necessary in the case of denitrifying bacteria.

Advantages of conversion of sulfide into sulfur rather than sulfate include: much less oxygen, and thus less energy is required, the process proceeds much faster, less biological sludge is produced, no sulfate or thio-sulfate is discharged, no sulfoxy acids are formed, and there is the possibility of reusing the sulfur.

A problem connected with biological waste water systems is that sulfide(s) adversely affects the purification efficiency and the sludge retention during aerobic purification of waste water based on a process wherein activated sludge is used. One of the reasons is that sulfide oxidizing, filamentous bacteria such as those of the genera Thiothrix and Beggiatoa can develop in the treatment plants. These filamentous bacteria hamper an efficient settlement of sludge, causing sludge to wash out (bulking out). This has two undesired consequences: a: decrease of the activity of the waste treatment plant resulting in a lower purification performance; and b: increase of levies as a result of the increase of the COD load by the washed-out sludge.

A process for the removal of sulfide from waste water by oxidation of the sulfide to elemental sulfur is known from Dutch patent application 8801009, referenced herein, according to which the production of sulfur can be promoted by using a lower oxygen supply than the stoichiometric amount that is needed for sulfate formation. Although a substantial amount of sulfur is produced using this known process, there is a need for improvement of this production, in order to minimize the discharge of soluble sulfur compounds such as sulfide and sulfate.

Another process for the removal of sulfide from waste water by conversion to elemental sulfur is presented in U.S. Pat. No. 5,705,072 and 6,136,193, referenced herein; in these patents, strains of Thiobacillus are presented to convert H₂S and SO₂ into elemental sulfur within the Thiobacillus bacterium. However, these patents do not present a method of scrubbing a gas stream or of removing the sulfur from the Thiobacillus bacterium.

To date there are many chemical and biological processes in use for the removal of sulfides from a gas stream via an aqueous media. Most of the chemical processes oxidize sulfur to sulfate and then dispose of the resultant aqueous sulfate salts. Many applications include the Claus Chemical Process which chemically converts sulfides to sulfur via the following redox reaction:

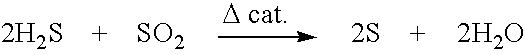

While the Claus process is rather efficacious and economical, the Claus process requires a chemical balance of H₂S and SO₂. If the Claus reaction is out of balance, either H₂S or SO₂ must be supplied to place the reaction back into chemical balance or the excess H₂S or SO₂ must be discharged to the atmosphere; this is while the odor threshold of H₂S is about 8 ppb and that of SO₂ is about 3 ppm.

Shell Paques has performed much research into the scrubbing of a gas stream containing sulfides wherein the sulfides are oxidized to sulfur or to sulfate in an alkaline aqueous media. Some of the chemical reactions for this process are:

2 H₂S+2NaOH [symbol] S+2H₂O+Na₂S+½H₂

2 H₂S+4NaOH [symbol] Na₂SO₄+Na₂S+4 H₂

2 SO₂+2NaOH [symbol] S+H₂O+Na₂S+3/2O₂

2 SO₂+4NaOH [symbol] Na₂SO₄+Na₂S+2 O₂

These reactions all occur in an aqueous environment; therefore, the Na₂SO₄ is actually in the form of 2 Na⁺+SO₄⁻ while the Na₂S is actually in the form of 2 Na⁺+S⁻. As S²⁻ and HS⁻quickly oxidizes in an aqueous environment, the S²⁻ and HS⁻ is further converted to S and Na₂SO₄. Unfortunately, this process has drawbacks in that once formed, the sulfate salts must be disposed. Further, formation of sulfur in its natural state, an S₈ ring, creates plugging issues for process piping. Said plugging issues lead to the requirement of a significant aqueous dilution factor in process equipment and piping, which leads to significant expense in the handling of large quantities of water. Shell Paques has presented anaerobic systems wherein the SO₄ is converted back into H₂S in order for a sulfur oxidizing bacterium to convert the H₂S into elemental S. Any partially converted H₂S which forms as SO₂ is then oxidized to SO₄ for further anaerobic conversion to H₂S. While effective, the combination of anaerobic and aerobic systems, along with chemical oxidation equipment makes such solutions to the formation of sulfate salts rather impractical. Shell Paques patents referenced herein include U.S. Pat. Nos. 4,609,460; 4,622,147; 4,707,254; 4,707,254; 4,758,339; 5,196,176; 5,338,447; 5,354,545; 5,366,633; 5,431,819; 5,449,460; 5,518,618; 5,518,619; 5,565,098; 5,637,220; 5,773,526; 5,904,850; 5,972,219; 5,976,868; 6,045,695; 6,063,273; 6,156,205; 6,221,652; 6,485,646; 6,630,071; 6,656,249; 6,758,886; 6,841,072; and 6,852,305.

Removal of sulfides is further complicated in liquid carbon fuels, wherein the raw liquid fuel, often crude oil, contains nitrogen moieties such as ammonia, ammonium hydroxide and carbon-nitrogen compounds, normally measured as total Kjeldahl nitrogen (TKN). During biological degradation TKN is converted to ammonium hydroxide. During nitrification ammonium hydroxide is converted to at least one of nitrite and nitrate.

### Ammonia Nitrification

For treating the ammonia content of wastewaters, certain aerobic messophilic autotrophic microorganisms can oxidize ammonia to nitrite (NO₂), while additional messophilic autotrophic microorganisms can microbially oxidize nitrite to nitrate (NO₃). Said reaction sequence is known as Nitrification. The microorganisms which perform nitrification are known as nitrifiers and are herein defined as nitrifiers.

Nitrification reduces the total ammonia-nitrogen content of a wastewater. Ammonia in water primarily takes the form of ammonium hydroxide and is removed from the wastewater by bacterial oxidation to NO₃ using bacteria that metabolize nitrogen. Nitrification to NO₃ is carried out by a limited number of bacterial species and under restricted conditions including a narrow range of pH and temperature and dissolved oxygen levels, along with reduced CCOD and reduced Biological Oxygen Demand (BOD) levels. Atmospheric oxygen is used as the oxidizing agent. Nitrifying bacteria grow slowly and nitrogen oxidation is energy poor in relation to messophilic or thermophilic carbon oxidation. In addition, nitrification is inhibited by the presence of a large number of compounds, including organic ammonium compounds, sulfide(s) and NO₂. A concentration of only 3 ppm of sulfides can significantly inhibit nitrification, while a concentration of only 5 ppm of sulfides can kill nitrosomonas, the bacteria which form NO₂. Furthermore, nitrifying bacteria subsist only under aerobic conditions and require inorganic carbon (CO₃⁻ or HCO₃⁻) for growth. Approximately 4 pounds of oxygen and approximately 6 pounds of carbonate and/or bicarbonate are required for every pound of ammonia converted to nitrate.

Ammonia exists primarily as NH₃ in a gas, while ammonia can exist as both ammonium hydroxide (NH₄OH) and NH₃ in water. In water, as the ammonium hydroxide concentration approaches approximately 150 ppm and the pH approaches approximately 8.0, ammonium hydroxide is converted into gaseous NH₃. At ammonium hydroxide concentrations of approximately above 350 ppm and the pH approximately above 8.0, NH₃ toxicity exists in the water. In addition to being toxic, ammonia gas is volatile, having a significant vapor pressure.

### Mercaptan (Thiol) Conversion

Mercpatan(s), broadly defined herein as carbon based molecules or carbon based compounds comprising sulfur, are often converted to sulfides when the mercaptan(s) is consumed by bacterium (bacteria). While mercaptans exist in many man-made compounds, mercaptan(s) occur naturally in the cells of nearly all animal species.

As a mercaptan(s) is converted to a sulfide(s), sulfides are toxic to nitrification, as stated above. Therefore, in order to perform nitrification in the presence of sulfides and/or mercaptan(s), sulfides must be removed in order for nitrification to effectively occur.

Similar to sulfides and ammonium hydroxide, liquid carbon fuels, often based upon crude oil, contain mercaptan(s).

### Sulfur Consuming Bacteria

In recent years, there have been identified many strains of bacteria (or bacterium) which metabolize or consume sulfur in their biomass. Most of these strains of bacterium are obligate aerobes capable of taking oxygen, SO₂, SO₃, NO₃, and NO₃ as an electron donor source for the conversion of H₂S to S. Most of these strains have difficulty or react slowly to convert SO₄ to S. Many of these strains of bacteria are capable of operating in an aerobic environment. For the aerobic strains, unfortunately, an aerobic environment is not preferred as in an aerobic environment a portion of the sulfides are converted to sulfate. Therefore, the facultative or anoxic strains are preferred in the conversion of sulfides to S so as to minimize the formation of sulfate.

Strains of bacteria known for their conversion of sulfides to elemental sulfur in their biomass include but are not limited to: strains of the genus Thiobacillus with the strain Thiobacillus denitrificanus most known and as presented in U.S. Pat. No. 6,126,193 and U.S. Pat. No. 5,705,072, both of which are referenced herein; gram-negative bacteria from the beta or gamma subgroup of Proteobacteria, obligate autotrophs, Thioalkalovibrio, strain LMD 96.55, Thioalkalobacter, alkaliphilic heterotrophic bacteria, and Pseudomonas strain ChG 3, all of which as described in U.S. Pat. No. 6,156,205, referenced herein. Further strains are described in U.S. Pat. No. 7,101,410, referenced herein and which lists: Rhodococcus erythropolis, Rhodococcus rhodochrous, other Rhodococcus species, Nocardia erythropolis, Nocardia corrolina, other Nocardia species Pseudomonas putida, Pseudomonas oleovorans, other Pseudomonas species, Arthrobacter globiformis, Arthobacter Nocardia paraffinae, Arthrobacter paraffineus, Arthrobacter citreus, Arthrobacter luteus, other Arthrobacter species, Mycobacterium vaccae JOB and other species of Mycobacterium Acinetobacter sp. (rag) and other species of Acinetobacter, Corynebacterium sp. and other Corynebacterium species, Thiobacillus ferrooxidans, Thiobacillus intermedia, other species of Thiobacillus Shewanella sp., Micrococcus cinneabareus, other micrococcus species, Bacillus sulfasportare and other bacillus species Fungi, White wood rot fungi, Phanerochaete chrysosporium Phanerochaete sordida, Trametes trogii, Tyromyces palustris, other white wood rot fungal species Streptomyces fradiae, Streptomyces globisporus, and other Streptomyces species, Saccharomyces cerrevisiae, Candida sp., Cryptococcus albidus and other yeasts Algae.

### Sulfur Salt—Cationic Moiety and Sulfur in the Form of a Salt or Compound

At 0° C. about 437 cc of H₂S will dissolve in about 100 cc of water. This solubility reduces to about 186 cc in 100 cc of water at 100° C., ref. CRC Handbook of Chemistry & Physics, 56'th Edition, 1975. However, H₂S water solubility is dependant upon pH, as well as temperature. As researched by John Carroll, AQUAlibrium©, A Discussion of the Effect of pH on the Solubility of Hydrogen Sulfide, 1998, at 25° C. and 1 atmosphere pressure, at a pH of about less than 6 the total water solubility of H₂S is about 0.1 molal and from about 6 to 8 pH the water solubility of H₂S increases to about 1.0 molal. However, the at 25° C. and 1 atmosphere pressure, a pH of below about 6.0 reveals the soluble form of H₂S is actually H₂S, while between a pH of about 6.0 and 8.0 the soluble form of H₂S changes into HS⁻, and at a pH of greater than about 7.0, the predominant form of H₂S is HS⁻.

In reference to the above reactions of H₂S with NaOH (which would be similar with any earth metal, Group IA or IIA metal hydroxide), HS⁻ would readily convert to S or SO₄.

SO₂ has a water solubility of about 23 gm per 100 cc of cold water and about 0.6 gram per 100 cc of hot water, ref. CRC Handbook of Chemistry & Physics, 56'th Edition, 1975. However, H₂S water solubility is dependant upon pH, as well as temperature. Upon contact with water SO₂ begins forming sulfurous acid, H₂SO₃.

H₂S reacts readily with cationic moieties, such as: the earth metals (Group I and II of the periodic table; heavy metals (Groups III B, IV B, V B, VI B, VII B, VIII, IB, and IIB of the periodic table; ammonium hydroxide; cationic carbon based molecules, such as ammonium compounds, cationic polyelectrolytes, etc. This is due to the rather strong negative ionic charge on the sulfur atom in the hydrogen sulfide molecule and the ease for which hydrogen sulfide will give up its hydrogen atoms.

Ammonium hydroxide reacts with hydrogen sulfide to form ammonium hydrogen sulfide, NH₄HS. Ammonium hydroxide reacts with sulfuric acid to form ammonium sulfate, (NH₄)₂SO₄.

About all metals react with H₂S to form the corresponding Metal sulfide.

### Use of Sulfur Consuming Bacteria to Purify Metals

Sulfur consuming bacteria have recently been incorporated in the purification of heavy metals which exist as the metal sulfide. U.S. Pat. No. 6,630,071, referenced herein, presents a process for the treatment of waste water containing heavy metals in which sulfur components and/or metals are biologically reduced to precipitate the metals as water-insoluble metal species, which are separated from the waste water. However, the '071 patent does not address the removal of sulfides from a gas stream or the removal of a cationic molecule other than a heavy metal from sulfur.

An economical and effective process is needed for the removal of at least one of: sulfides, mercaptains, TKN and ammonia from a gas. Further, an economical and effective process is needed for the removal of at least one of: sulfides, mercaptains, TKN and ammonia from a carbon fuel source.

### SUMMARY OF THE INVENTION

A primary object of the instant invention is to devise environmentally friendly, effective, efficient and economically feasible methods, processes and apparatus for the removal of sulfides from a gas.

Another object of the instant invention is to devise environmentally friendly, effective, efficient and economically feasible methods, processes and apparatus for the removal of at least one of sulfides, mercaptains, TKN and ammonia from a gas.

Still another object of the instant invention is to devise environmentally friendly, effective, efficient and economically feasible methods, processes and apparatus for the removal of at least one of: sulfides, mercaptains, TKN and ammonia from a carbon fuel source.

Still further, another object of the instant invention is to devise effective, efficient and economically feasible methods, processes and apparatus which remove sulfides from a gas and do not produce large quantities of a Group IA or IIA sulfate salt.

Still further yet, another object of the instant invention is to devise effective, efficient and economically feasible methods, processes and apparatus which remove at least one of: sulfides, mercaptains, TKN and ammonia from a carbon fuel source while not producing large quantities of a Group IA or IIA sulfate salt.

Further yet still, another object of the instant invention is to devise effective, efficient and economically feasible methods, processes and apparatus for the scrubbing of a gas comprising sulfides, wherein sulfur plugging does not create the need to dilute scrubber water and therein create the use of large quantities of scrubber water to dilute the sulfur.

Still also further, another object of the instant invention is to devise effective, efficient and economically feasible methods, processes and apparatus to work in conjunction with the Claus Process so as to provide the Claus Process an ability to operate in a way that there is no significant release of H₂S or of SO₂.

Additional objects and advantages of the instant invention will be set forth in part in a description which follows and in part will be obvious from the description, or may be learned by practice of the invention.

### BRIEF DESCRIPTION OF THE DRAWINGS

A better understanding of the present invention can be obtained when the following descriptions of the preferred embodiments are considered in conjunction with the following drawings, in which:

FIG. 1 illustrates a legend for FIGS. 2 through 8.

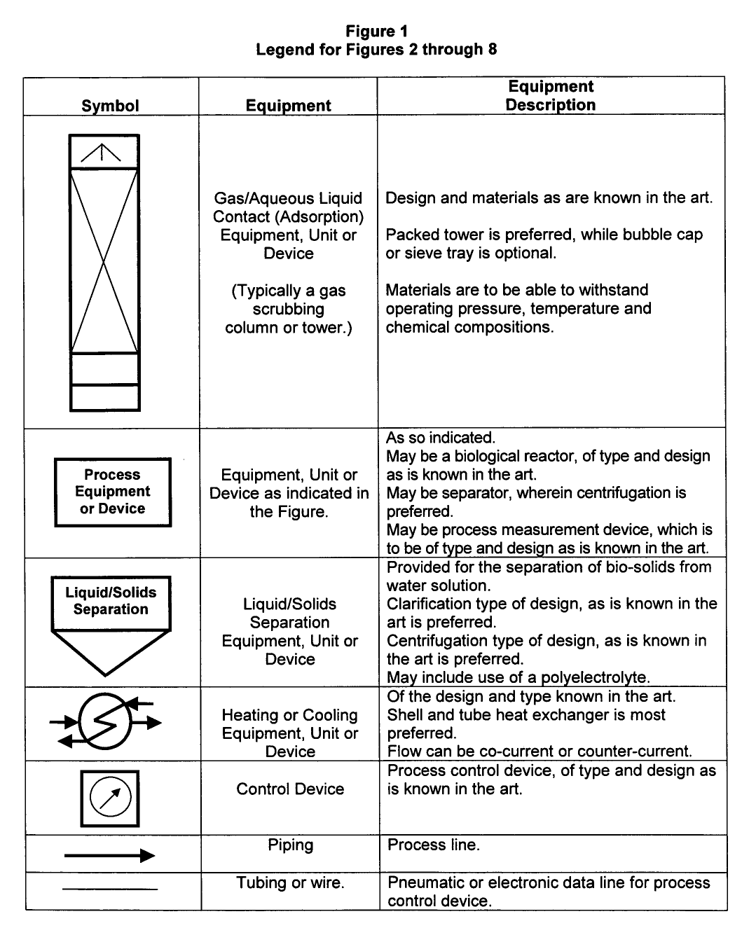

FIG. 2 illustrates a graphical representation of a gas purification flow diagram, including a gas adsorption unit and a Sulfur Biological Reactor (SBR). The gas stream is preferably air or a carbon based gas contaminated with a sulfide(s), such as natural gas.

FIG. 3 illustrates a graphical representation of a gas purification flow diagram, including an SBR and an Aerobic Biological Reactor (ABR). The gas stream is preferably air or a carbon based gas contaminated with at least one selected from the group consisting of a sulfide(s), mercaptan(s), ammonia, TKN, COD, and any combination therein.

FIG. 4 illustrates a graphical representation of a gas purification flow diagram, including a Claus reactor and an SBR. The gas stream is preferably air or a carbon based gas contaminated with a sulfide(s), such as natural gas.

FIG. 5 illustrates a graphical representation of a gas purification flow diagram, including a Claus reactor, an SBR and an ABR. The gas stream is preferably air or a carbon based gas contaminated with at least one selected from the group consisting of a sulfide(s), mercaptan(s), ammonia, TKN, COD, and any combination therein.

FIG. 6 illustrates a graphical representation of a liquid hydrocarbon carbon fuel purification flow diagram, including an SBR.

FIG. 7 illustrates a graphical representation of a liquid carbon fuel purifying flow diagram, including an SBR and an ABR.

FIG. 8 illustrates a graphical representation of a solid carbon fuel purifying flow diagram, including an SBR and an ABR. It is preferred that the solid carbon fuel be of a type of coal, as is known in the art. The solid carbon fuel is preferably of a type of coal, as is known in the art.

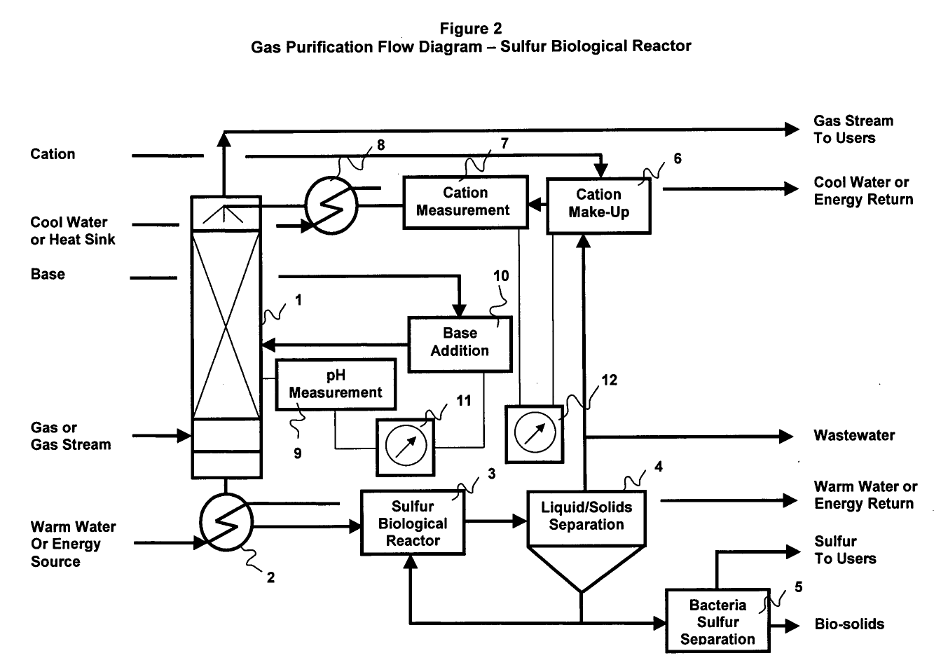

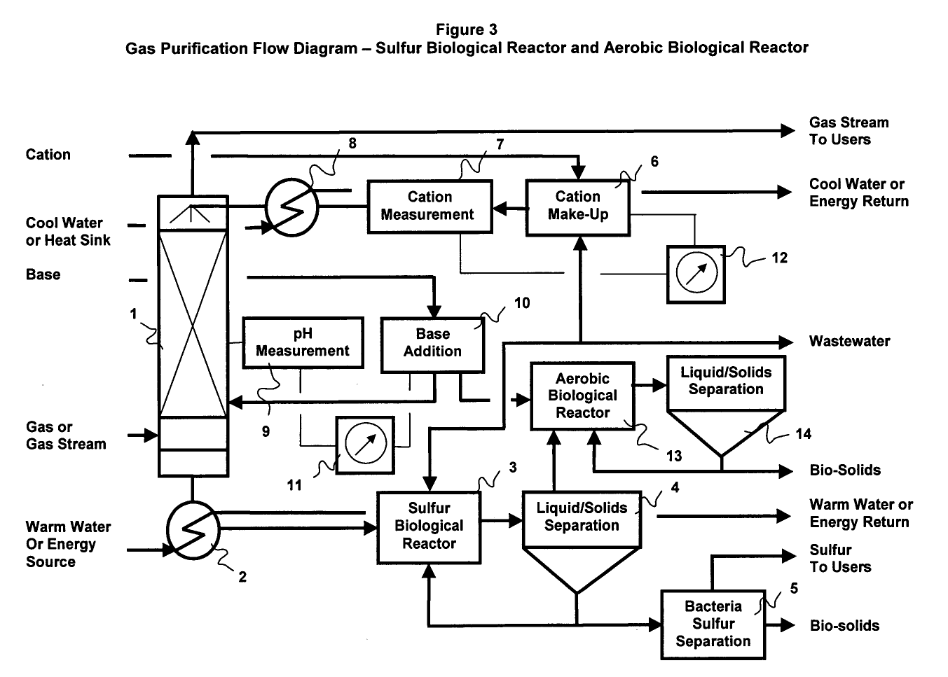

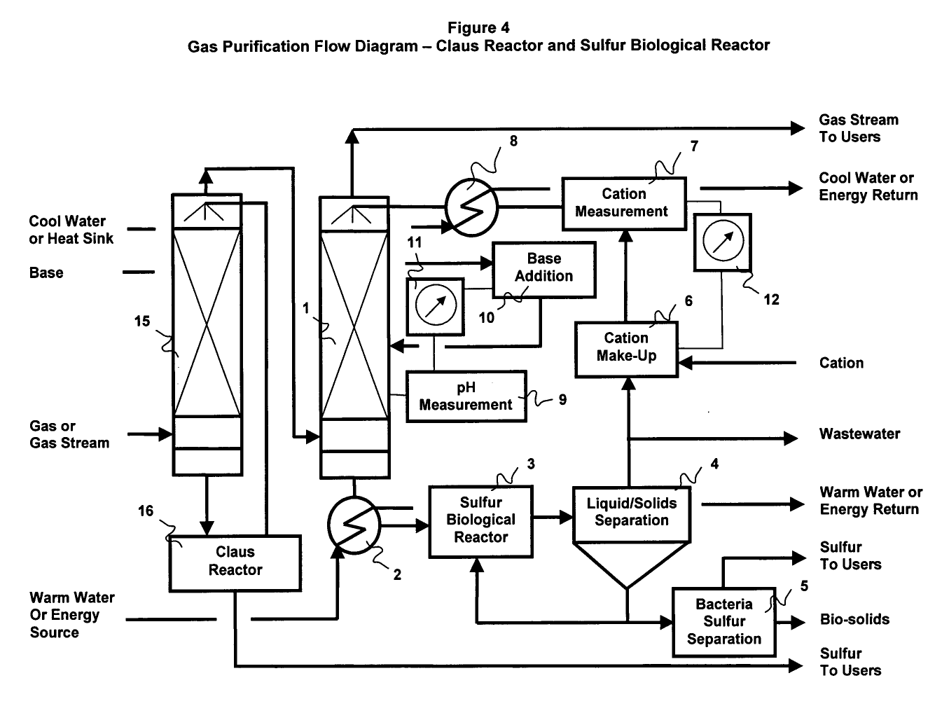

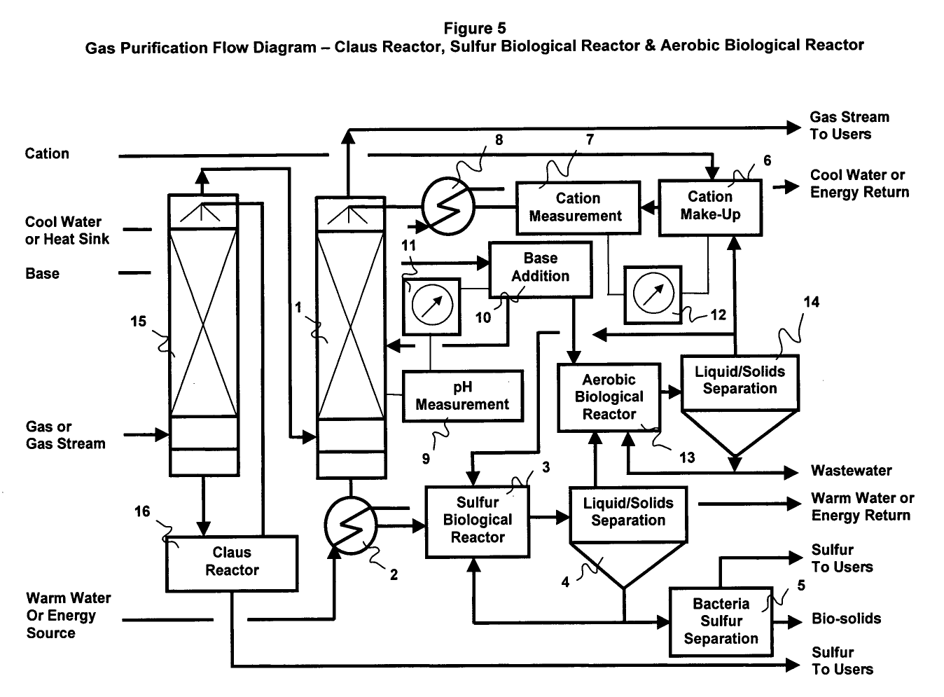

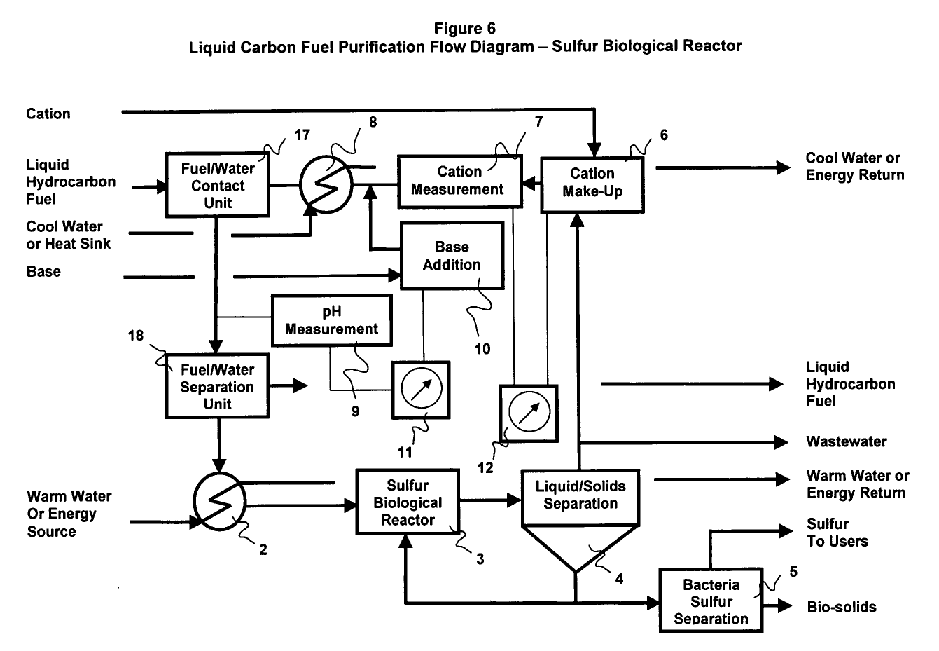

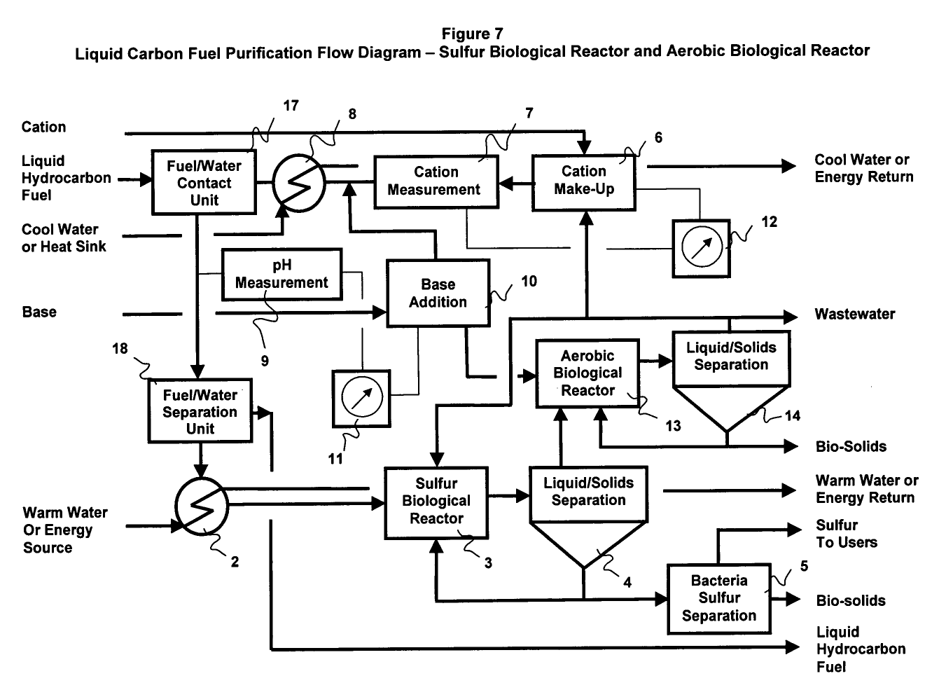

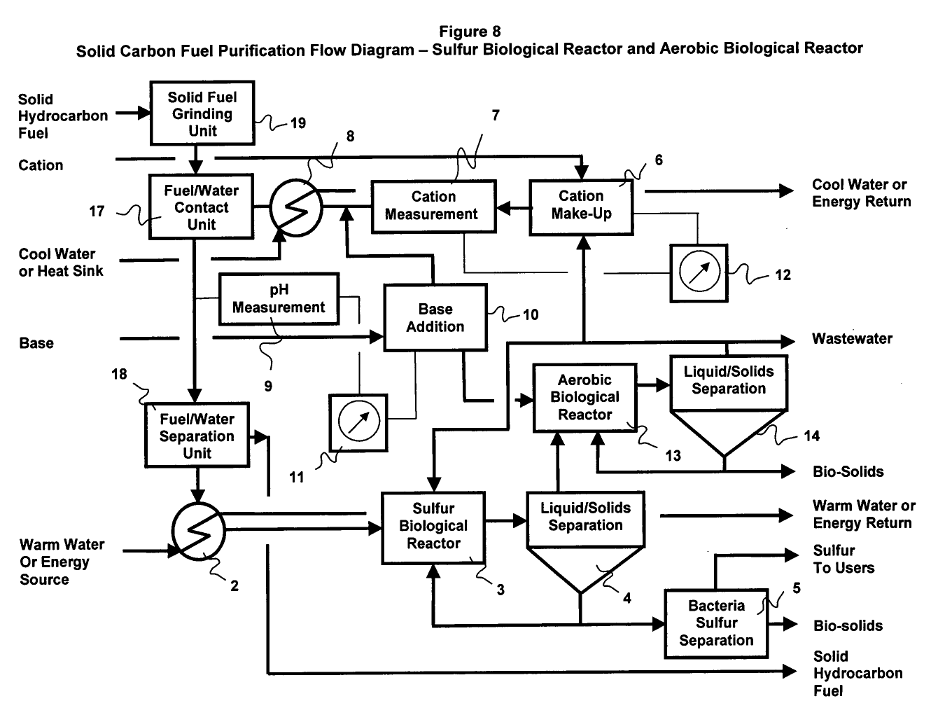

Within FIGS. 2 through 8, it is preferred that the cation make-up be an aqueous solution comprising the cationic moiety.

### DETAILED DESCRIPTION OF THE PREFERRED EMBODIMENTS

Timing of the instant invention is significant as air quality is becoming a global issue. The timing of the instant invention is significant since the availability of oil and natural gas, sources of hydrocarbons for hydrocarbon combustion, are becoming global issues. The timing of the instant invention is significant since the market of natural gas (methane, ethane, propane and/or butane) is affecting the production and/or market price of electricity. The timing of the instant invention is significant since air pollution is becoming a health issue for much of humanity, as well as a weather issue due to global warming. The discovered instant invention presents environmentally friendly methods, processes and apparatus which remove undesirable contaminants form a gas or a fuel, whether the fuel be a gas, liquid or a solid.

The methods, processes, systems and apparatus of the instant invention utilize the metabolism of bacteria capable of consuming sulfides. The methods, processes, systems and apparatus of the instant invention utilize the negative anionic capability of sulfur in the hydrogen sulfide molecule to react with a cationic moiety. The methods, processes, systems and apparatus of the instant invention utilize the metabolism of bacterium to purify at least one selected from the group consisting of a gas, liquid, solid and any combination therein, wherein the bacterium consume at least one selected from the group consisting of a: sulfide(s), mercaptains(s), ammonia, ammonium hydroxide, TKN and CCOD.

In the instant invention, it is an embodiment to adsorb at least a portion of the sulfide(s) within a gas, liquid or solid (substance) into an aqueous solution, wherein the pH of the aqueous solution is below about 8.0. It is preferred to adsorb at least a portion of the sulfide(s) into an aqueous solution wherein the pH of the aqueous solution is below about 7.0. It is most preferred to adsorb at least a portion of the sulfide(s) into an aqueous solution wherein the pH of the aqueous solution is between about 6.0 and about 7.0. It is preferred that in the case wherein the pH of the aqueous solution needs to be reduced, that a form of nitric or nitrous acid be added to said aqueous solution. It is preferred that in the case wherein the pH of the aqueous solution needs to be increased, that at a base selected from the group consisting of: magnesium oxide, magnesium hydroxide, a form of bicarbonate, a form of hydroxide, and any combination therein be added to said aqueous solution. It is most preferred that in the case wherein the pH of the aqueous solution needs to be increased, that a base selected from the group consisting of: magnesium oxide, magnesium hydroxide, a form of bicarbonate, and any combination therein be added to said aqueous solution. It is preferred in the case wherein the pH of the aqueous solution needs to be reduced that an acid be added to the aqueous solution. It is most preferred in the case wherein the pH of the aqueous solution needs to be reduced that a sulfurous or sulfuric acid be added to the aqueous solution.

In the instant invention, it is preferred to adsorb at least a portion of the sulfide(s) into an aqueous solution, wherein adsorption is preformed in any type of adsorption unit contacting the substance to be purified with the aqueous solution, thereby creating a scrubber exit water. It is most preferred to adsorb at least a portion of the sulfide(s) within a substance into an aqueous solution, wherein the adsorption unit is an adsorption column or tower, as is known in the art, thereby creating a scrubber exit water.

In the instant invention, it is an embodiment that the aqueous solution be cooled prior to or during adsorption. It is an embodiment that the aqueous solution comprise a temperature above about 0° C. and below about 100° C. It is preferred that the aqueous solution comprise a temperature above about 0° C. and below about 50° C. It is most preferred that the aqueous solution comprise a temperature above about 0° C. and below about 20° C.

In the instant invention, it is preferred to reduce the concentration of the sulfide(s) in said scrubber exit water by reacting the sulfide(s), within the scrubber exit water by biological means, herein termed a Sulfur Biological Reactor (SBR). It is preferred that said SBR comprise at least one strain of bacteria capable of consuming sulfur in its bio-mass. It is most preferred that said at least one strain of bacteria capable of consuming sulfur in its bio-mass be facultative, e.g. capable of obtaining an electron donor from a sulfur or nitrogen oxide salt. It is preferred that said at least one strain of bacteria capable of consuming sulfur in its biomass be capable of using oxygen as an electron donor source. It is most preferred that said at least one strain of bacteria capable of consuming sulfur in its bio-mass be of the genus Thiobacillus. It is preferred that said SBR operate with a dissolved oxygen concentration of about less than 1 ppm in the biomass/aqueous solution. It is most preferred that said SBR operate with a dissolved oxygen concentration of about greater than 0.1 ppm to about less than 0.5 ppm in the biomass/aqueous solution. Said SBR is embodied to be of the aerobic design and type as is known in the art. Said SBR is preferred to be of the facultative or anoxic design and type as is known in the art.

In the instant invention, it is preferred that the aqueous solution be heated prior to or during reaction in said SBR. It is an embodiment that the aqueous solution prior to or during reaction in said SBR comprise a temperature above about 10° C. and below about 40° C. It is preferred that the aqueous prior to or during reaction in said SBR comprise a temperature above about 20° C. and below about 40° C. It is most preferred that the aqueous prior to or during reaction in said SBR comprise a temperature above about 30° C. and below about 40° C.

In the instant invention, it is preferred that the biomass and aqueous solution exiting said SBR be mostly separated from each other in a liquid/solids separation device, as is known in the art. It is most preferred that the biomass and aqueous solution exiting said SBR be mostly separated from each other in a clarifier, as is known in the art. It is most preferred that the biomass and aqueous solution exiting said SBR be mostly separated from each other with the aid of a cationic coagulating agent, as is known in the art.

In the instant invention, it is preferred that the biomass separated from the bio-mass and aqueous solution exiting said SBR (SBR separated biomass) be recycled back to said SBR. It is most preferred that at least a part of the time at least a portion of said SBR separated bio-mass be sent to a second separation device, wherein the sulfur within the biomass is separated from the biomass. It is most preferred that said second separation device be of centrifugation type, as is known in the art.

In the instant invention, it is preferred that the aqueous solution separated from the biomass and aqueous solution (water) exiting the SBR (SBR separated water) be recycled to said adsorption as a scrubber (adsorption) inlet water. It is preferred that the pH of the SBR separated water be maintained as the aqueous solution described above for entry and use in adsorption.

In the instant invention, in the case wherein said substance to be purified comprises at least one selected from a group consisting of: mercaptan(s), TKN, CCOD, ammonia, and any combination therein, it is preferred that, prior to recycle, said SBR separated water enter an aerobic biological reaction means, as is known in the art, herein termed an Aerobic Biological Reactor (ABR). It is preferred that said ABR comprise at least one heterotroph. It is preferred that said ABR comprise at least one nitrifier. It is preferred that said nitrifier(s) comprise nitrosomonas. It is preferred that said nitrifier(s) comprise nitrobactor. It is preferred that the dissolved oxygen content in the biomass/aqueous solution of said ABR be between about 0.5 and about 3.0 ppm.

It is preferred, in the case wherein said ABR comprises nitrifier(s) that the M-Alkalinity of said ABR be about greater than 100 mg/L. It is preferred, in the case wherein said ABR comprise nitrifier(s) that there be added to said ABR at least one selected from the group consisting of: lime, hydrated lime, bicarbonate, magnesium oxide, magnesium hydroxide, and any combination therein.

In the instant invention, it is preferred that the biomass and aqueous solution exiting said ABR be mostly separated from each other in a liquid/solids separation device, as is known in the art. It is most preferred that the biomass and aqueous solution exiting said ABR be mostly separated in a clarifier, as is known in the art. It is most preferred that the biomass and aqueous solution exiting said ABR be mostly separated from each other with the aid of a cationic coagulating agent, as is known in the art.

In the instant invention, it is preferred that the biomass separated from the bio-mass and aqueous solution exiting said ABR (ABR separated bio-mass) be recycled back to the ABR. It is most preferred that at least a part of the time at least a portion of the ABR separated biomass be sent to a second separation device, wherein said ABR separated bio-mass is further separated from the water. It is preferred that said further separation device be of centrifugation type, as is known in the art. It is preferred that a cationic polyelectrolyte be added to the biomass/water mixture to facilitate separation of said ABR separated bio-mass from said water.

In the instant invention, it is preferred that the aqueous solution separated in said liquid/solids separation device from the biomass and aqueous solution exiting said ABR (ABR separated water) be recycled to said substance adsorption as an inlet water. It is preferred that the pH of the ABR separated aqueous solution be maintained as described previous for entry into and use in said adsorption. It is preferred that at least a portion of said ABR separated aqueous solution be recycled back into said SBR. It is most preferred that at least a portion of said ABR separated aqueous solution be recycled back into said SBR when the separated ABR aqueous solution comprises oxides of nitrogen or of sulfur.

It is preferred that said substance comprises a liquid hydrocarbon fuel. It is preferred that the aqueous phase from contact of said liquid hydrocarbon fuel with an aqueous solution, herein termed hydrocarbon fuevaqueous solution contact be separated, wherein the liquid hydrocarbon fuel is separation from the aqueous solution. The liquid hydrocarbon fuel and aqueous phase separation is to be as is known in the art of organic liquid/aqueous separation. It is preferred that the aqueous phase effluent from said liquid hydrocarbon fuel/aqueous separation be sent to said SBR and processed, as described previously. In the case wherein said liquid hydrocarbon fuel comprises at least one selected from a group consisting of: mercaptan(s), TKN, CCOD, ammonia, and any combination therein, it is preferred that said SBR separated aqueous phase enter an ABR and be processed, as described previously.

It is preferred that said substance adsorption comprise the contact of a solid hydrocarbon fuel with an aqueous solution. It is preferred that prior to said contact that said solid hydrocarbon fuel be ground so as to increase the surface area of said solid hydrocarbon fuel. Said grinding is to be of the type and design as is known in the art. It is preferred that the effluent from said contact be separated, wherein the solid hydrocarbon fuel is separated from the aqueous solution. The means of separation is to be as is known in the art of solid(s)/aqueous separators. It is preferred that the aqueous solution effluent from said solids(s)/water separator is to be sent to an SBR and processed, as described previously. In the case wherein said solid hydrocarbon fuel comprises at least one selected from a group consisting of: mercaptan(s), TKN, CCOD, ammonia, and any combination therein, it is preferred that said SBR separated aqueous solution enter an ABR and be processed, as described previously.

It is preferred that said aqueous solution comprises a cationic moiety. It is an embodiment that said cationic moiety comprise hydrogen. It is most preferred that said cationic moiety comprise an amine. It is most preferred that said cationic moiety comprise ammonium. It is preferred that said cationic moiety comprise nitrogen. It is most preferred that said nitrogen in said cationic moiety comprise quaternized nitrogen. It is preferred that said cationic moiety be a Group IA or IIA metal. It is an embodiment that said cationic moiety comprise a heavy metal. It is preferred that said cationic moiety be at least one selected from the group consisting of: ammonium hydroxide, an amine, a metal, and any combination therein.

It is preferred that gas adsorption operate downstream of a Claus Type sulfide(s) gas removal, such that said gas adsorption operate to remove from the H₂S and/or SO₂ gas which is not removed by the Claus Type sulfide(s) removal unit.

It is preferred to define a process flow path wherein at least one unit adsorb a sulfide(s) from a substance in an aqueous solution, wherein the aqueous solution exiting said adsorption unit enter an SBR comprising bacteria capable of consuming sulfur into their bio-mass. It is preferred that said bacteria capable of consuming sulfur into their bio-mass comprise a species from the genus Thiobacillus. It is preferred that said process flow path further comprise a liquid/solids separation unit downstream of said SBR, wherein the bio-mass and the aqueous solution from said SBR are mostly separated. It is preferred that said process flow path further comprise the return to said SBR of said SBR separated biomass. It is most preferred that at for at least some of the time at least a portion of said SBR separated bio-mass be sent to a second separation device, wherein sulfur is separated from the SBR separated biomass. It is most preferred that said second separator be of centrifugation design, as is known in the art of centrifugation.

It is preferred that the process flow path further comprise a unit to heat or cool the aqueous solution prior to or during adsorption. It is an embodiment that the aqueous solution comprise a temperature above about 0° C. and below about 100° C. It is preferred that the aqueous solution comprise a temperature above about 0° C. and below about 50° C. It is most preferred that the aqueous solution comprise a temperature above about 0° C. and below about 20° C. It is most preferred that said heat or cooling unit be a heat exchanger design and type as is known in the art.

In the instant invention, it is preferred that the process flow path further comprise a unit to heat or cool the aqueous solution prior to or during reaction in said SBR. It is an embodiment that the aqueous solution prior to or during reaction in said SBR have a temperature above about 10° C. and below about 40° C. It is preferred that the aqueous solution prior to or during reaction in said SBR have a temperature above about 20° C. and below about 40° C. It is preferred that the aqueous solution prior to or during reaction in said SBR have a temperature above about 30° C. and below about 40° C. It is most preferred that said heat or cooling unit be a heat exchanger design and type as is known in the art.

It is preferred that said process flow path further comprise a device measuring the pH of the aqueous solution from said SBR. It is preferred that a unit add cationic moiety to said separated aqueous solution as is required to maintain the required pH in the water as the aqueous solution is transferred back to said adsorption unit. It is most preferred that said cationic moiety comprise a cationic moiety as described previously. It is preferred that a unit add cationic moiety to said SBR separated aqueous solution as is required to maintain the required pH in the aqueous solution as the water is transferred back to said adsorption unit. It is preferred that a unit add a base to said SBR separated aqueous solution as is required to maintain the required pH in the aqueous solution as the aqueous solution is transferred back to said adsorption unit. It is most preferred that said base comprise a base as described previously.

In the case wherein said substance comprises at least one selected from the group consisting of: mercaptan(s), TKN, ammonia, CCOD, and any combination therein, it is preferred that said process flow path further comprise an ABR downstream of said solids/liquid separation device and prior to said pH measurement device, wherein the aqueous solution from said SBR liquid/solids separation device enters said ABR. It is preferred that said process flow path further comprise an ABR solids/liquid separation unit, wherein the biomass and aqueous solution from said ABR are mostly separated. It is preferred that the aqueous solution separated from said biomass and aqueous solution be sent to said device measuring the pH of the aqueous solution. It is preferred that said process flow path further comprise the recycle of at least a portion of said aqueous solution from said ABR liquid/solids separation unit to said SBR. It is most preferred that said ABR separated biomass be further separated from aqueous solution with a second liquid/solids separation unit. It is preferred that said second liquid/solids separation unit comprise centrifugation. It is preferred that the further separation of aqueous solution from said ABR separated bio-mass be enhanced with a cationic polyelectrolyte, as is known in the art of liquid/solids separation.

It is preferred that said adsorption unit comprise a liquid hydrocarbon fuel and operate downstream of an aqueous solution contact unit. It is preferred that said process flow path comprising said liquid hydrocarbon fuel and aqueous solution contact unit further comprise the addition of aqueous solution comprising a cationic moiety to said liquid hydrocarbon fuel and aqueous solution contact unit. It is most preferred that said cationic moiety comprise a cationic moiety as described previously. It is preferred that said process flow path comprising said liquid hydrocarbon fuel and aqueous solution contact unit further comprise an organic liquid/aqueous separator unit downstream of said liquid hydrocarbon fuel and aqueous solution contact unit. It is preferred that said process flow path comprising said liquid hydrocarbon fuel and aqueous solution contact unit and said organic liquid/water separator, transfer the aqueous solution from said organic liquid/water separator to said SBR to be processed, as described previously.

It is preferred, in the case wherein said liquid hydrocarbon fuel is a crude oil that said liquid hydrocarbon fuel and aqueous solution contact unit be downstream of any required desalting.

It is preferred that said adsorption unit comprises a solid hydrocarbon fuel and operate downstream of an aqueous solution contact unit. It is preferred that said process flow path comprising said solid hydrocarbon fuel and aqueous solution contact unit further comprise a solid hydrocarbon fuel grinding unit prior to, upstream of, said solid hydrocarbon fuel and aqueous solution contact unit. It is preferred that said process flow path comprising said solid hydrocarbon fuel and aqueous solution contact unit further comprise the addition of a water comprising a cationic moiety to said solid hydrocarbon fuel and aqueous solution contact unit. It is most preferred that said cationic moiety comprise a cationic moiety as described previously. It is preferred that said process flow path comprising said solid hydrocarbon fuel and aqueous solution contact unit further comprise a solids/aqueous separator downstream of said solid hydrocarbon fuel and aqueous solution contact unit. It is preferred that said process flow path comprising said solid hydrocarbon fuel and aqueous solution contact unit and said solids/aqueous separator, transfer the aqueous solution from said solids/aqueous separator to said SBR to be processed, as described previously.

It is preferred that any hydrocarbon gas be purified of at least a portion of at least one selected from the group consisting of: a sulfide(s), a mercaptan(s), TKN, CCOD, ammonia, and any combination therein, be used as a fuel. It is preferred that any liquid hydrocarbon cleaned of at least a portion of at least one selected from the group consisting of: a sulfide(s), a mercaptan(s), TKN, CCOD, ammonia, and any combination therein, be used as a fuel. It is preferred that any solids hydrocarbon cleaned of at least a portion of at least one selected from the group consisting of: a sulfide(s), a mercaptan(s), TKN, CCOD, ammonia, and any combination therein, be used as a fuel.

It is preferred that a fuel purified by the instant invention be used in at least one of: transportation, electrical energy production or to generate heat.

Certain objects are set forth above and made apparent from the foregoing description. However, since certain changes may be made in the above description without departing from the scope of the invention, it is intended that all matters contained in the foregoing description shall be interpreted as illustrative only of the principles of the invention and not in a limiting sense. With respect to the above description, it is to be realized that any descriptions, drawings and examples deemed readily apparent and obvious to one skilled in the art and all equivalent relationships to those described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention, It is also to be understood that the following claims are intended to cover all of the generic and specific features of the invention herein described, and all statements of the scope of the invention, which, as a matter of language, might be said to fall in between.

I claim:

1. A method of purification, wherein the substance to be purified is at least one of a gas, a liquid hydrocarbon and a solid hydrocarbon, wherein
the substance comprises at least one sulfide, wherein
the substance is contacted with an aqueous solution having a pH of about less than 8.0, wherein
the sulfide(s) are adsorbed in the aqueous solution during contact with the substance, wherein
the concentration of sulfide(s) in the aqueous solution are reduced within the aqueous solution by reaction of the sulfide(s) in aqueous solution with bacteria capable of consuming the sulfide(s), wherein
after reaction with the bacteria capable of consuming the sulfide(s), the aqueous solution at a pH of about less than 8.0 is recycled to be contacted further with substance to be purified, and wherein
the aqueous solution contacting the substance comprises a cationic moiety.

2. The method of claim 1, wherein said cationic moiety comprises the hydrogen ion.

3. The method of claim 1, wherein said cationic moiety comprises at least one selected from the group consisting of: ammonium hydroxide, an amine, a metal, and any combination therein.

4. The method of claim 3, wherein said amine comprises a quaternized nitrogen.

5. The method of claim 3, wherein said metal is a heavy metal,

6. The method of claim 1, wherein the pH of said aqueous solution contacted with said substance is greater than about 6.0 and about less than about 7.0.

7. The method of claim 1, wherein said bacteria capable of consuming the sulfide(s) comprise the genus Thiobacillus.

8. The method of claim 1, further comprising separation of said aqueous solution from said bacteria capable of consuming the sulfide(s).

9. The method of claim 8, wherein said separation comprise centrifugation.

10. The method of claim 8, wherein said separation comprises the addition of a cationic polyelectrolyte.

11. The method of claim 10, wherein at least a portion of said bacteria capable of consuming sulfide(s) separated from said aqueous solution is recycled to said substance.

12. The method of claim 10, wherein at least part of the time at least a portion of said bacteria capable of consuming the sulfide(s) separated sulfur.

13. The method of claim 12, wherein said separation comprises centrifugation.

14. The method of claim 1, further comprising a Claus type reactor prior to said substance contacted with an aqueous solution having a pH of about less than 8.0

15. The method of claim 1, further comprising aerobic biological treatment of the aqueous solution after liquid/solids separation and before recycle to contact substance to be purified.

16. The method of claim 15, wherein the concentration of at least one selected from the group consisting of a: mercaptan(s), ammonium hydroxide, CCOD, TKN, and any combination therein
is reduced in said aqueous solution during said aerobic biological treatment.

17. The method of claim 15, wherein said aerobic biological treatment comprises at least one heterotroph.

18. The method of claim 15, wherein said aerobic biological treatment comprises at least one nitrifier.

19. The method of claim 15, wherein said aerobic biological treatment comprises at least one of nitrosomonas and nitrobactor.

20. The method of claim 15, wherein said biological treatment comprises an M-alkalinity of about greater than 100 mg/L.

21. The method of claim 15, wherein said aerobic biological treatment comprises at least one selected from the group consisting of: magnesium oxide, magnesium hydroxide, carbonate, lime, and any combination therein.

22. The method of claim 15, further comprising separation prior to recycle, wherein the bacteria and the aqueous solution from said aerobic biological reactor are mostly separated.

23. The method of claim 22, further comprising at least a portion of said aqueous solution from said separation to said reaction of the sulfide(s) in aqueous solution with bacteria capable of consuming the sulfide(s).

24. The method of claim 22, wherein the bacteria from said separation is recycled to said aerobic biological treatment.

25. The method of claim 22, further comprising additional separation, wherein the bacteria from said aerobic biological treatment is further separated from the aqueous solution.

26. The method of claim 25, wherein said additional separation comprises centrifugation.

27. The method of claim 25, wherein said additional separation comprises the addition of a cationic polyelectrolyte.

28. The method of claim 1, wherein the substance is a gas.

29. The method of claim 1, wherein the substance is a liquid hydrocarbon fuel.

30. The method of claim 29, wherein after said liquid hydrocarbon fuel is contacted with an aqueous solution having a pH of about less than 8.0
said liquid hydrocarbon fuel is separated from said aqueous solution.

31. The method of claim 1, wherein the substance is a solid hydrocarbon fuel.

32. The method of claim 31, wherein after said solid hydrocarbon fuel is contacted with an aqueous solution having a pH of about less than 8.0
said solid hydrocarbon fuel is separated from said aqueous solution.

33. The method of claim 31, wherein said solid hydrocarbon fuel is ground to increase the surface area of said solid hydrocarbon fuel.
